(19) United States
(12) Patent Application Publication
(10) Pub. No.: US 2013/0047497 A1
(43) Pub. Date: Feb. 28, 2013

(54) INSECT CONTROL SYSTEM

(71) Applicant: Jeffrey C. White, Katy, TX (US)

(72) Inventor: Jeffrey C. White, Katy, TX (US)

(21) Appl. No.: 13/598,326

(22) Filed: Aug. 29, 2012

Related U.S. Application Data
(60) Provisional application No. 61/528,510, filed on Aug. 29, 2011.

(51) Int. Cl. E04B 1/72; A01M 1/00; A01M 1/20

(52) U.S. Cl. 43/131; 52/173.1; 43/132.1

(57) ABSTRACT

A system and method for controlling the breeding of insects is provided. The system may have a larvacide release device. The larvacide release device may have a housing, a reservoir, and an actuator. The reservoir may be configured to contain a larvacide for impairing the ability of mosquitoes to breed. The actuator may be configured to release the larvacide from the reservoir and into a water system.

### CROSS REFERENCE TO RELATED APPLICATIONS

This application claims the benefit of U.S. Provisional Patent Application No. 61/528,510 filed Aug. 29, 2011. This related application is hereby incorporated by reference in its entirety.

### STATEMENTS REGARDING FEDERALLY SPONSORED RESEARCH OR DEVELOPMENT

Not applicable.

### NAMES OF PARTIES TO A JOINT RESEARCH AGREEMENT

Not applicable.

### BACKGROUND

Embodiments of the inventive subject matter generally relate to field of controlling insects. More specifically, embodiments of the inventive subject matter generally relate to device for releasing a larvacide into a water system.

Typically people control insects such as mosquitoes by spraying insect repellant on their body. This may prevent the insects from coming near the person, but it leaves a film on the person. The chemicals in the insect repellant may be harmful to the person if the person uses them long term. Therefore there is a need to prevent the insects from attacking the person without the need for a spray on insect repellant.

### BRIEF SUMMARY

A system and method for controlling the breeding of insects is provided. The system may have a larvacide release device. The larvacide release device may have a housing, a reservoir, and an actuator. The reservoir may be configured to contain a larvacide for impairing the ability of mosquitoes to breed. The actuator may be configured to release the larvacide from the reservoir and into a water system.

As used herein the terms “larva” or “larvae” may be used interchangeably and are to be understood to be interchangeable.

### BRIEF DESCRIPTION OF THE DRAWINGS

The present embodiments may be better understood, and numerous objects, features, and advantages made apparent to those skilled in the art by referencing the accompanying drawings.

FIG. 1 depicts a schematic of an insect control system 100 according to an embodiment.

FIGS. 2A and 2B depict schematic views of a larvacide release device proximate the water system according to an embodiment.

FIG. 3 depicts a schematic view of the larvacide release device in a sewer system.

FIG. 4 depicts a larva control unit according to an embodiment.

FIG. 5 depicts a method of using the insect control system.

### DESCRIPTION OF EMBODIMENT(S)

The description that follows includes exemplary apparatus, methods, techniques, and instruction sequences that embody techniques of the present inventive subject matter. However, it is understood that the described embodiments may be practiced without these specific details.

Embodiments may take the form of a mechanical system, an entirely hardware embodiment, an entirely software embodiment (including firmware, resident software, micro-code, etc.) or an embodiment combining mechanical, software and hardware aspects that may all generally be referred to herein as a “circuit,” “module” or “system.” Furthermore, embodiments of the inventive subject matter may take the form of a computer program product embodied in any tangible medium of expression having computer usable program code embodied in the medium. The described embodiments may be provided as a computer program product, or software, that may include a machine-readable medium having stored thereon instructions, which may be used to program a computer system (or other electronic device(s)) to perform a process according to embodiments, whether presently described or not, since every conceivable variation is not enumerated herein. A machine readable medium includes any mechanism for storing or transmitting information in a form (e.g., software, processing application) readable by a machine (e.g., a computer). The machine-readable medium may include, but is not limited to, magnetic storage medium (e.g., floppy diskette); optical storage medium (e.g., CD-ROM); magneto-optical storage medium; read only memory (ROM); random access memory (RAM); erasable programmable memory (e.g., EPROM and EEPROM); flash memory; or other types of medium suitable for storing electronic instructions. In addition, embodiments may be embodied in an electrical, optical, acoustical or other form of propagated signal (e.g., carrier waves, infrared signals, digital signals, etc.), or wire line, wireless, or other communications medium.

Computer program code for carrying out operations of the embodiments may be written in any combination of one or more programming languages, including an object oriented programming language such as Java, Smalltalk, C++ or the like and conventional procedural programming languages, such as the “C” programming language or similar programming languages. The program code may execute entirely on a user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN), a personal area network (PAN), or a wide area network (WAN), or the connection may be made to an external computer (for example, through the Internet using an Internet Service Provider).

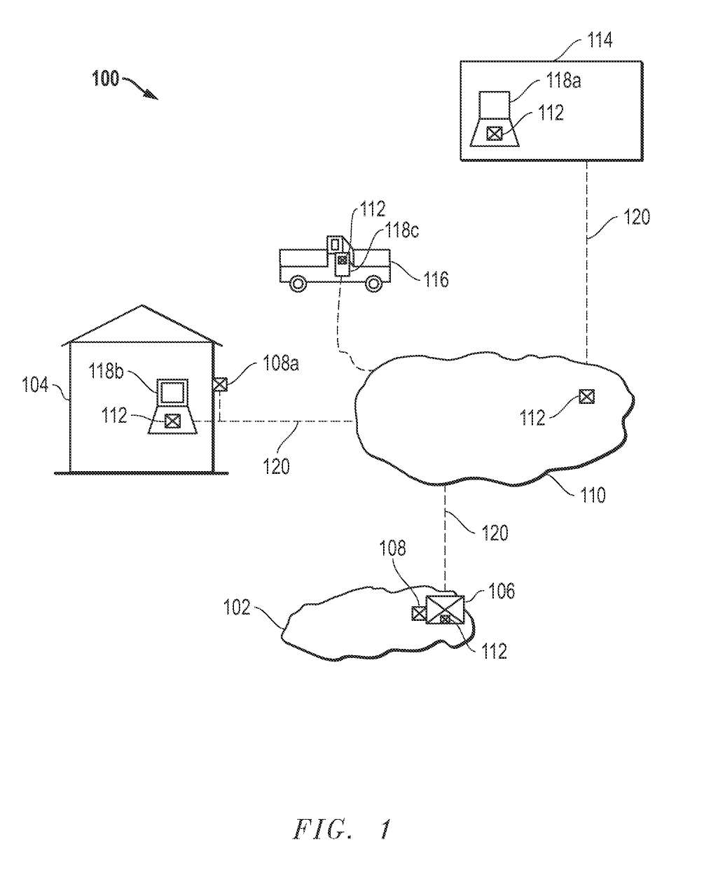

FIG. 1 depicts a schematic an insect control system 100 according to an embodiment. The insect control system 100 as shown is used in a water system 102 proximate a building 104. The insect control system 100 may have a larvacide release device 106 located within or proximate the water system 102. The larvacide release device 106 may be configured to release a larvacide into the water system 102 in order to kill or impair insect larvae. Killing or impairing the insect larvae may prevent the insect from thriving in the water system 102 and proximate the building 104. The larvacide may be released into the water system 102 based on any number of criteria as will be discussed in more detail below. The insect control system 100 may include, but is not limited to, the larvacide release device 106, one or more sensors 108, a communication network 110, one or more larva control units 112 (or controllers), an operator's facility 114, an operators maintenance vehicle 116, and the like. The one or more larva control unit 112 may allow the larvacide release into the water system 102 to be controlled, regulated, monitored and maintained in an at least partially automated manner as will be discussed in more detail below.

The water system 102 as shown in FIG. 1 is a water retention area in a yard or field. The water retention area may be any area that retains water for long periods when it rains. Mosquitoes breed in temporary bodies of water void of fish and other predators. Although the water system 102 is shown in FIG. 1 as a water retention area, it should be appreciated that the water system 102 may be any suitable location for retaining a sufficient amount of water for breeding mosquitoes including, but not limited to, a drainage ditch, a gutter, a drain system, stagnant water source, and the like.

The building 104 as shown is a house proximate the water system 102. Although the building 104 is shown as a house it should be appreciated that the building 104 may be any suitable location where humans go and want to control the amount of mosquitoes in the area including, but not limited to, an office, a retail shop, a mall, a school, a church, a park, a restaurant, a bar, an amusement park, an arena, and the like. The building 104 may have one or more computers 118b that may communicate with the larva control units 112. As shown, the computer 118b may wholly or partially contain the larva control unit 112. The computer 118b may be any suitable computer including, but not limited to, a desktop computer, a laptop, a tablet, a phone, a personal digital assistant, a controller and the like. The building computer 118b may allow the owner of the building to monitor, control, and/or manipulate the larvacide release device 106 as will be discussed in more detail below.

The building 104 may have one or more sensors 108a for detecting current conditions proximate the building 104. The sensor 108a may communicate with the larva control units 112 via the communication lines 120. The sensors 108a may include but are not limited to a thermometer, a bug detection device, a barometer, and the like. The bug detection device may monitor the density of the bugs, for example mosquitoes proximate the building 104.

The operator's facility 114 may be any building or facility where the company selling and/or maintaining the insect control system 100 has their business. As shown, the operator's facility 114 is an office building, but it may be any suitable facility. The operator's facility 114 may have one or more computers 118a. The computers 118a may wholly or partially contain the larva control unit 112. The computers may be any suitable computer including those described herein. The facility computers 118a may allow the operator to monitor, control, and/or manipulate the larvacide release device 106 and/or any portion of the insect control system 100 as will be discussed in more detail below.

The operator's maintenance vehicle 116 may be a maintenance vehicle that allows one or more workers to drive to the water system 102 and install and/or maintain the larvacide release device 106. The operator's maintenance vehicle 116 may be any suitable vehicle including, but not limited to, a truck, a car, a van, a bus, and the like. The operator's maintenance vehicle 116 may have one or more computers 118c. The computers 118c may wholly or partially contain the larva control unit 112. The computers 118c may be any suitable computer including those described herein. The vehicle computers 118c may allow the worker to monitor, control, and/or manipulate the larvacide release device 106 and/or any portion of the insect control system 100 as will be discussed in more detail below.

The larva control unit 112 maybe located wholly and/or partially in the larvacide release device 106, the communication network 110, the computer 118a at the operator's facility 114, the computer 118b in the building 104 and/or the computer 118c in the operator's maintenance vehicle 116. The larva control unit 112 may communicate with the network 110 to facilitate communication about the insect control system 100. The network 110 may be a computer network, a phone network, a satellite system, a cellular phone system, a Wi-Fi network, a wireless sensor network, a cable service network, a local area network (LAN), a personal area network (PAN), or a wide area network (WAN), or the connection may be made to an external computer (for example, through the Internet using an Internet Service Provider), the cloud, and the like. The larva control unit 112 may communicate with the network 110 via one or more communication links 120. The communication links 120 may be any suitable means for transmitting data, or power such as cables, wireless communication devices, electrical, optical, acoustical or other form of propagated signal (e.g., carrier waves, infrared signals, digital signals, etc.), or wireless, or other communications medium, and the like. The network 110 may allow the operator's facility 114 to access the larva control unit 112 and communicate with the entire insect control system 100 as will be discussed in more detail below.

The larvacide may be any type of chemical configured to kill, mutate, and/or impair the larvae of insects. Larvacide may be specifically designed to target the larval stage of an insect, such as a mosquito. Larvacides may be contact poisons, stomach poisons, growth regulators, biological control agents, and the like.

For example, the larvacide may eliminate the larvae or it may mutate the larvae's reproduction capabilities. By way of example, some acceptable larvacides may be, but are not limited to NYGUARD IGR CONCENTRATE, methoprene, Bacillus thuringiensis israelensis (BTI), Temephos, ALTOSID, APEX, DIACON, DIANEX, KABAT, MINEX, PHARORID, PRECOR, ZR-515 and the like. The larvacide may come in the form of granular pellets that dissolve in the water of the water system 102 upon release. In another embodiment, the larvacide may be a liquid or gel that is sprayed into the water system. In another embodiment, the larvacide may come in the form of bricks and/or charcoal sized forms. The insects are typically mosquitoes, but it should be appreciated that the insects may be any suitable insect including, but not limited to flies, gnats, fleas and the like.

The larvacides may be released into water from the water system 102, and/or be placed in the water system 102 while the water system is dry. If the water system 102 is dry, the larvacide may remain inactivated until water is present in the system. Upon the presence of water, the larvacide may begin to dissolve and thereby impact the larvae of the mosquitoes.

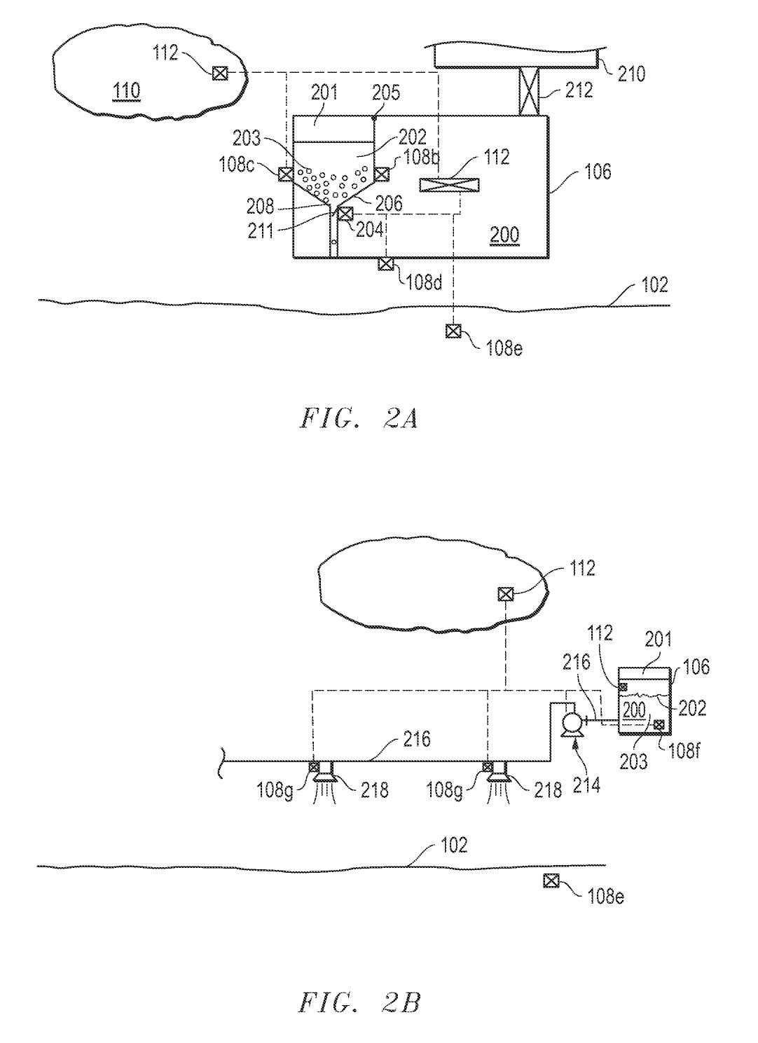

FIG. 2A depicts a schematic view of the larvacide release device 106 proximate the water system 102 according to an embodiment. The larvacide release device 106 may have a housing 200, a lid 201, a reservoir 202 for containing the larvacide 203, and an actuator 204. The larvacide release device 106 may be water tight to prevent water from entering the reservoir 202 and damaging the larvacide 203 and/or the actuator 204. The lid 201 may open and close to allow an operator to fill the reservoir 202 with the larvacide 203. As shown, the lid 201 has a hinge 205 configured to allow the lid 201 to open while remaining attached to the housing 200. The reservoir 202 as shown has a sloped bottom 206 with a port 208 (or access way) at the lowest point in the sloped bottom 206. The sloped bottom 206 feeds the larvacide toward the port 208.

The actuator 204 may release the larvacide into the water system 102 at the given interval. As shown the actuator opens a door 211 in the port 208. The door 211 as shown is a hinged door that the actuator 204 moves toward an open position. The hinged door may be biased toward the closed position. The actuator 204 may be any suitable actuator including, but not limited to, a servo, a piston, a motor with one or more gears, and the like. When the door 211 is in the open position, as shown in FIG. 2A, the larvacide 203 may flow through the port 208 and into the water system 102. Although the actuator 204 is shown to open a door 211 that releases the larvacide, it should be appreciated that any suitable system may be used to release the larvacide 203 into the water system 102 including, but not limited to, a control valves, one-way valves, doors, conveyors and the like.

The port 208 as shown is a tube within the housing 200 below the reservoir 202. The port 208 may provide a pathway for the larvacide 203 to travel through toward the water system 102. Although the port 208 is shown as a pathway, it should be appreciated that any suitable port may be used including but not limited to, no port, a conveyor, a ramp and the like.

The larvacide release device 106 may have the whole or portion of larva control unit 112. The larva control unit 112 may control the actuator 204 in an embodiment. In an embodiment, the larva control unit 112 is simply a timer that actuates the actuator 204 and predetermined time intervals. In this embodiment, the operator or operator's worker would set the time intervals in the larva control unit 112. The actuator 204 would then release the larvacide at the given time intervals into the water system 102. In another embodiment, the larva control unit 112 may monitor, manipulate, and control the insect control system 100 in a fully automated manner as will be discussed in more detail below.

The larvacide release device 106 may include one or more sensors 108 or 108b-g. As shown the larvacide release device 106 has a reservoir level sensor 108b, an external condition sensor 108c, a larvacide release sensor 108d, and a water sensor 108e. All of the sensors 108a-g (note there may be additional sensors not shown beyond 108a-g) may be in communication with the larva control unit 112. The reservoir level sensor 108b may measure the level of the larvacide 203 in the reservoir 202. The external condition sensor 108c may measure the external conditions around the larvacide release device 106 including, but not limited to, the temperature, the humidity, presence of water, bug density and the like. The larvacide release sensor 108d may measure the amount of larvacide that is being released into the water system 102. The water sensor 108e may sense the condition of the water in the water system 102. For example, the water sensor 108e may detect the presence of water, the depth of water, the water temperature, the amount of larvacide in the water, and the like. The sensors 108a-g may be used to control and optimize the insect control system 100 as will be discussed in more detail below.

As shown in FIG. 2A, the larvacide release device 106 is in a sewer system having a grating 210. The larvacide release device 106 may have a connector 212 that couples the housing 200 to the grating 210. The connector 212 may be any suitable device or system for coupling the larvacide release device 106 to the grating 210 including, but not limited to, clamps, hanger rods, screws, any combination thereof and the like.

FIG. 2B depicts an alternative embodiment of the larvacide release device 106 wherein the larvacide 203 is a liquid. In this embodiment, the larvacide release device 106 may have the housing 200, the lid 201, reservoir 202, the larvacide 203, a pump system 214, one or more flow lines 216, one or more nozzles 218 and one or more sensors 108 a-g. The pump system 214 may pump the larvacide 203 from the reservoir 202 to the nozzles 218 and thereby the water system 102. The alternative embodiment may include a liquid reservoir sensor 108f and a nozzle sensor 108g in addition to any suitable sensors described above. The alternative larvacide release device 106 may operate on a time interval as discussed above, or be fully automated and regulated as will be discussed below in more detail.

In another embodiment, the larvacide may be the brick and/or charcoal sized larvacide. The larvacide release device may launch the larvacide into large bodies of water in order to impact the growth of the mosquito larvae in the large body of water. The launcher may be any suitable launcher including a catapult, a slingshot, a baseball type launcher and the like. The launcher may allow the larvacide to reach the inner portion of the water source from the shore. In another embodiment, the brick and/or charcoal sized larvacide may be simply dropped using the larvacide release device 106 in the water source 102 in order to dissolve slowly over time.

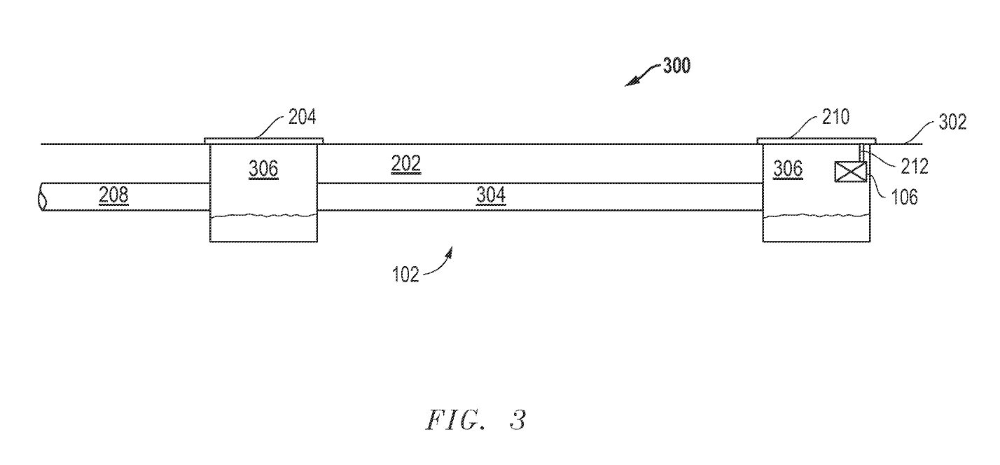

FIG. 3 depicts a schematic view of the larvacide release device 106 in a sewer system 300. As shown, the grating 210 of the sewer system 300 device may be located at a ground surface 302. One or more pipes 304 may couple one or more catch basins 306 and/or a drainage grid. The larvacide release device 106 may have the connector device 212 configured to couple the larvacide release device 106 to the grating 210, the catch basin 306 and/or any other suitable location proximate the water system 102. Any of the sensors 108a-g may be used in conjunction with the sewer system 300.

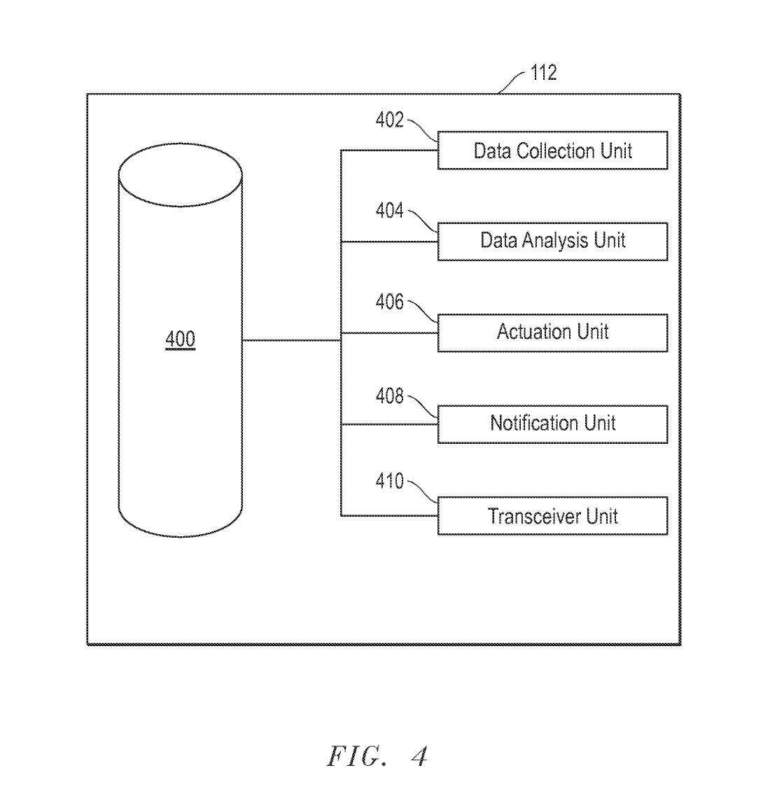

FIG. 4 depicts a block diagram of the larva control unit 112 according to an embodiment. The larva control unit 112 may have a storage device 400, a data collection unit 402, a data analysis unit 404, an actuation unit 406, a notification unit 408 and a transceiver unit 410. The storage device 400 may be any suitable storage device for storing data including those described herein. The transceiver unit 410 may be any suitable device configured to send and/or receive data about the insect control system 100. The larva control unit 112 may be totally or partially located in the network 110, the one or more of the computers 118a-c (note there may be additional computers not shown beyond 118a-c) and/or the larvacide release device 106.

The data collection unit 402 may collect data from the sensors 108a-g, user input, and/or the computers 118a-c. The data collection unit 402 may store, manipulate, and categorize all of the data collected by the insect control system 100. For example, the sensors 108a-g may collect the temperature at the building 104, the temperature in the water system 102, the level of larvacide 203 in the reservoir 202, the position of the actuator, the concentration of larvacide 203 in the water system 102, the insect density at the building 104, and the like. Further, the operator, the worker and/or a person in the building 104 may input data into the computers 118a-c that will be collected by the data collection unit 402. The computer input may include, but is not limited to, type of larvacide used, time and/or date larvacide filled, user input on bug density, user input regarding number of people at building 104, when maintenance was performed, and the like. The data collection unit 402 will store this data for access by other units as will be discussed in more detail below.

The data analysis unit 404 may access the data stored in the data collection unit 402 in order to determine how the insect control system 100 is operating. From the data collected, the data analysis unit 404 may determine if the larvacide level is too low, if the actuator is operating properly, if the temperature of the water system 102 is too low for breeding mosquitoes, if the temperature is right for breeding mosquitoes, if there is water in the water system 102, if there are mosquitoes proximate the building 104, if the concentration of larvacide in the water is sufficient to control mosquitoes, and the like.

The actuation unit 406 may access data from the data collection unit 402 and/or the data analysis unit 404 to determine when the larvacide 203 will be released. When the actuation unit 406 determines that the larvacide 203 is to be released into the water system 102, the actuation unit 406 may instruct the actuator 204 (as shown in FIG. 2A) and/or the pump system 214 (as shown in FIG. 2B) to operate. Actuating the actuator 204 and/or the pump system 214 releases the larvacide 203 into the water system 102. The actuation unit 406 may determine the amount of larvacide 203 to release into the water system 102. For example, the actuation unit 406 may have predetermined amounts that are released based on the type of larvacide 203 used in the reservoir 202. The actuation unit 406 may instruct the actuator 204 to open the door 211 for an amount of time that is consistent with the release of the predetermined amount of larvacide 203. Further, the actuation unit 406 may instruct the pump system 214 to pump the larvacide 203 for a predetermined time into the water system 102. In another embodiment, the operator and/or a person in the building 104 may instruct the actuation unit of the amount of time to release the larvacide from one of the computers 118a-c.

In an additional embodiment, the actuation unit 406 may determine when to actuate the actuator 204 and/or the pump system 214 based on the environmental data in the insect control system 100. For example, the actuation unit 406 may receive data regarding the water presence and/or temperature in the water system 102. The actuation unit 406 may then only release the larvacide 203 when there is water present and the temperature is suitable for mosquito breeding.

In an additional embodiment, the actuation unit 406 may release more or less larvacide based on the density of the mosquito population at the building 104. The mosquito density may be determined by user input at one of the computers 118a-c, or by one of the sensors 108a-g at the building 104. If there are many mosquitoes at the building 104, the actuation unit 406 may increase the frequency and/or amount of larvicide 203 releases. If there is a low population of mosquitoes at the building 104, the actuation unit 406 decreases and/or stops the frequency and/or amount of larvacide 203 released into the water system 102.

The actuation unit 406 may use any suitable criteria including any combination of those described herein for determining the time interval and the amount of larvacide 203 to release into the water system 102.

The notification unit 408 may access data from the data collection unit 402, the data analysis unit 404, and/or the actuation unit 406 to determine when to notify the operator, the worker, and/or a building user when action is required. For example, the notification unit 408 may receive data indicating that the larvacide 203 is running low. The notification unit 408 may then notify the operator, worker and/or end user that the larvacide 203 needs to be replenished. The notification unit 408 may send information regarding the amount of larvacide 203 left and how long before the larvacide 203 will run out based on usage. The notification unit 408 may further notify when the insect control system 100 needs maintenance. For example the notification unit 408 may receive data the one or more of the components of the insect control system 100 is not operating properly. The notification unit 408 may then send a notification regarding which component is not operating properly to the operator, the worker and/or the building user. Proper action may then be taken in order to maintain the insect control system 100 operating. The maintenance notification may regard any suitable system including, but not limited to, the actuator 204, the pump system 214, the sensors 108a-g, the computers 118a-c, and the like. Once the notification is received action may be taken by the operator, the worker and/or the building user.

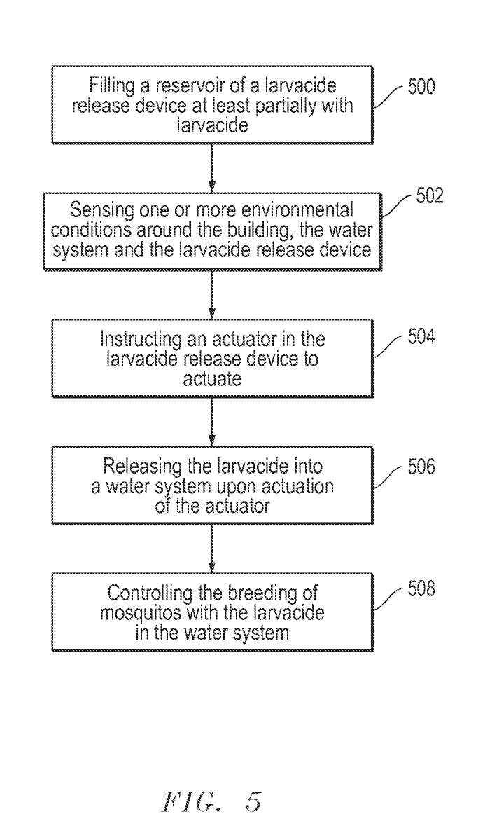

FIG. 5 depicts a flowchart of a method of using the insect control system 100 (as shown in FIG. 1). The flow starts at block 500 wherein a reservoir 202 of the larvacide control device 106 is at least partially filled with larvacide 203. The larvacide may be any suitable larvacide 203 including those described herein. The flow continues at block 502 wherein optionally one or more environmental conditions is sensed by one or more of the sensors 108a-g around the building 104, the water system 102 and the larvacide release device 106. The environmental conditions may be any suitable condition including, but not limited to, the water temperature, the air temperature, the larvacide level in the reservoir, the mosquito density, any condition described herein and the like. The flow continues at block 504 wherein an actuator 204 coupled to the larvacide release device 106 is instructed to actuate. The actuation may be based on a time interval, one of the environmental conditions user input, or any other suitable condition. The flow continues at block 506 wherein the larvacide 203 is released into the water system 102 upon actuation of the actuator 204. The flow continues at block 508 wherein the breeding of mosquitoes is controlled by the larvacide 203 acting within the water system 102.

While the embodiments are described with reference to various implementations and exploitations, it will be understood that these embodiments are illustrative and that the scope of the inventive subject matter is not limited to them. Many variations, modifications, additions, and improvements are possible. For example, the techniques used herein may be applied to several types of insects including, but not limited to, fleas, gnats, flies, and the like.

Plural instances may be provided for components, operations or structures described herein as a single instance. In general, structures and functionality presented as separate components in the exemplary configurations may be implemented as a combined structure or component. Similarly, structures and functionality presented as a single component may be implemented as separate components. These and other variations, modifications, additions, and improvements may fall within the scope of the inventive subject matter.

What is claimed is:

1. A larvacide release device, comprising:
a housing;
a reservoir configured to contain a larvacide for impairing the ability of mosquitoes to breed;
an actuator configured to release the larvacide from the reservoir and into a water system; and
a larva control unit configured to control the actuation of the actuator.

2. The larvacide release device of claim 1, wherein the larva control unit further comprises:
a data collection unit configured to store data collected by a insect control system;
a data analysis unit configured to analyze the data stored by the data collection unit;
an actuation unit configured to control the actuator; and
a notification unit configured to send one or more notifications regarding the larvacide release device.

3. The larvacide release device of claim 2, wherein the actuation unit actuates the actuator at a time interval.

4. The larvacide release device of claim 2, wherein the actuation unit actuates the actuator base on one or more environmental conditions surrounding the insect control system.

5. The larvacide release device of claim 4, wherein the one or more environmental conditions is the temperature of the water system.

6. The larvacide release device of claim 4, wherein the one or more environmental conditions is presence of mosquitoes at a building.

7. An insect control system, comprising:
a building;
a water system proximate the building;
a larvacide release device proximate the water system and configured to release a mosquito larvacide into the water system; and
a larva control unit configured to control the release of the larvacide into the water system.

8. The insect control system of claim 7, further comprising one or more sensors configured to monitor the insect control system.

9. The insect control system of claim 8, further comprising an operator's facility, one or more operator's vehicles and one or more computers configured to communicate with the larva control unit.

10. The insect control system of claim 8, wherein the larva control unit further comprises:
a data collection unit configured to store data collected by the one or more sensors;
a data analysis unit configured to analyze the data stored by the data collection unit;
an actuation unit configured to control the actuator; and
a notification unit configured to send one or more notifications regarding the larvacide release device.

11. The insect control system of claim 10, wherein the actuation unit actuates the actuator base on one or more environmental conditions detected by the one or more sensors.

12. The insect control system of claim 11, wherein the one or more environmental conditions is presence of water in the water system.

13. The insect control system of claim 8, wherein the one or more notifications further comprise a notification to an operator to fill the larvacide when one of the sensors detects low larvacide levels.

14. A method for controlling insects proximate a building, comprising:
filling a reservoir of a larvacide release device at least partially with larvacide;
instructing an actuator in the larvacide release device to actuate;
releasing the larvacide into a water system upon actuation of the actuator; and
controlling the breeding of mosquitoes with the larvacide in the water system.

15. The method of claim 14, further comprising sensing one or more environmental conditions around the building, the water system and the larvacide release device.

16. The method of claim 15, wherein instructing the actuator to actuate further comprises determining if the environmental conditions require the release of the larvacide.

17. The method of claim 15, further comprising storing data collected by the one or more sensors in a larva control unit.

18. The method of claim 15, further comprising notifying an operator of the larvacide level.

19. The method of claim 18, further comprising sending a technician to fill the reservoir of the larvacide release device upon receiving the notification.

20. The method of claim 15, further comprising adjusting the amount of larvacide released based on mosquito density at the building.
